(19) United States
(12) Patent Application Publication
(10) Pub. No.: US 2026/0128981 A1
(43) Pub. Date: May 7, 2026

(54) CACHE LOCALIZATION USING PREFIX BASED TARGETING

(71) Applicant: Disney Enterprises, Inc., Burbank, CA (US)

(72) Inventors: Eric C. FRIEDRICH, North Easton, MA (US); Joseph D. HIGGINS, Astoria, NY (US); Bradley A. TARNO, Austin, TX (US); Tiffeny E. CHEN, Manhasset, NY (US); Anthony D. DEGLIOMINI, Livingston, NJ (US); Richard J. STEIN, Jackson Heights, NY (US)

(21) Appl. No.: 18/939,445

(22) Filed: Nov. 6, 2024

(51) Int. Cl. H04L 45/12; H04L 67/568

(52) U.S. Cl. CPC H04L 45/123; H04L 67/568

(57) ABSTRACT

Aspects of the present disclosure provide techniques for improved cache localization. Network path data received from a plurality of routing advertisements for a communication network is aggregated, the communication network comprising a plurality of content delivery network (CDN) caches. Link utilization for a plurality of links in the communication network relating to the plurality of CDN caches is determined, and a connectivity table reflecting, for each of a plurality of routes in the communication network, one or more characteristics of the routes is generated. Communication between a requesting client and a first CDN cache, of the plurality of CDN caches, is routed based on the connectivity table and the determined link utilization.

### BACKGROUND

Content Distribution Networks (CDNs) are large, geographically spread networks of caches. These caches deliver video and other content (e.g., audio content, streaming video content, textual content, image content, electronic gaming content, or any other suitable content) to recipients. A typical large-scale content provider (e.g., a streaming video provider) uses multiple CDNs with multiple available caches to deliver content (e.g., streaming video) to recipients. Selecting the appropriate cache, and appropriate network route, for a given recipient is a challenging problem.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 illustrates a computing environment for cache localization, according to one embodiment.

FIG. 2 is a block diagram illustrating a controller for cache localization, according to one embodiment.

FIG. 3 is a flowchart illustrating cache localization, according to one embodiment.

FIG. 4 is a flowchart illustrating aggregating network path data for cache localization, according to one embodiment.

FIG. 5 is a flowchart illustrating determining link utilization for cache localization, according to one embodiment.

FIG. 6 illustrates a connectivity table for cache localization, according to one embodiment.

### DETAILED DESCRIPTION

One of the challenges for distributing content using CDNs is client localization. Given a client and the requested content, a system selects a CDN cache to deliver the content to the client. But selecting which cache to use is a problem with many dimensions. Different routes to fulfill client requests can have different latencies, and different costs (e.g., computational costs, monetary costs, or both). For example, a system could select the cache to use for servicing content based on client proximity to the cache (e.g., geographic proximity, network proximity, or any other suitable proximity), cache health, or cache capacity. One or more techniques described below address one of these dimensions: selecting a cache based on client proximity (e.g., network proximity), among other factors.

In one embodiment, the cache to use can be identified using geolocation. For example, an internet protocol (IP) geolocation database can be used to obtain latitude and longitude based on a requesting client IP address. The estimated client location can then compared to all cache locations to determine the closest cache. While this approach is relatively straightforward, because it can be implemented using existing IP geolocation databases and limited computation, it suffers from inaccuracies. For example, the client IP address may not accurately reflect the client's geographic location, and the geolocation database may not be accurate. As another example, even where the lookup is accurate, the closest geographic cache for a client is not necessarily the closest cache for the client in terms of network distance and may not be the preferred cache to serve content to the client.

Alternatively, or in addition, the cache can be identified using latency mapping. In an embodiment, latency mapping employs empirical measurements of client requests (e.g., previous client requests) to build a large, detailed map of the most suitable cache. But this approach is very computationally expensive, and requires processing large amounts of data to generate and maintain the map. Further, special considerations must be made for how to handle cache failure or changes in network paths.

A further approach is the use of Anycast. Typically, Internet traffic is routed using Unicast, in which traffic destined for a particular IP address is serviced by a single host advertising that IP address. Anycast allows the same IP address to be advertised from many hosts. At every hop, the switch or router determines the lowest cost path for the packet, automatically localizing clients to the closest cache. While this can be effective in identifying the closest cache for a client, in terms of network distance, it cedes control of localization to the network and does not allow fine control by the CDN or content provider. Further, load balancing is generally very challenging, especially if many clients are located close together.

One or more embodiments disclosed herein provide an improved approach for cache localization. In an embodiment, a connectivity table is created by aggregating network path data identified from a routing protocol and fusing it with real-time, or near real-time, usage telemetry. For example, routing advertisements (e.g., border gateway protocol (BGP) advertisements) can be used to identify available paths for available caches, and link capacity for these available paths. Usage telemetry can then be used to identify estimated real-time capacity available for those paths, to ensure a system does not add additional sessions to already saturated network links. In an embodiment, the connectivity table can then be used to route client requests for content to the appropriate cache using the appropriate link. This allows for routing based on real-time telemetry and prevents overload, both for links from a client device to a router, and for links from a router to a peer.

In an embodiment, one or more techniques described below provide significant technical advantages over other solutions. For example, as noted above use of geolocation for cache localization may be inaccurate, and may not identify the preferred cache by conflating geographic distance with network distance. One or more techniques disclosed herein improve on geolocation by accurately identifying a preferred cache in terms of network distance (e.g. as opposed to geographic distance). As another example, latency mapping is generally very computationally expensive, and typically requires processing large amounts of data. One or more techniques disclosed herein improve on latency mapping by providing a much more computationally efficient solution while accurately identifying a preferred cache route for a client request. Further, Anycast does not allow fine control (e.g., by the CDN or content provider) and makes load balancing very challenging. One or more techniques described herein allow for fine control and improved load balancing, while identifying a preferred cache for a client request.

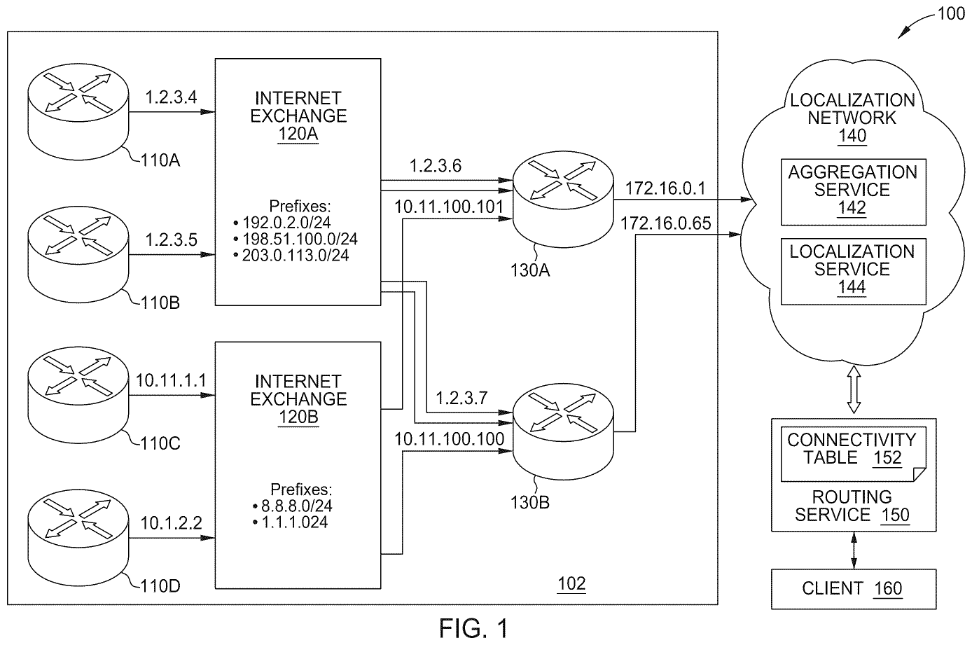

FIG. 1 illustrates a computing environment 100 for cache localization, according to one embodiment. In an embodiment, an aggregation service 142 gathers routing and usage information (e.g., BGP routing information) for a communication network 102. For example, the communication network 102 includes a number of peers 110A-D. In an embodiment, BGP routing uses peering, in which BGP peers exchange routing information with neighboring BGP peers. As one example, two routers that have established connection for exchanging BGP information can be referred to as peers. Further, in an embodiment, the various peers 110A-D are associated with respective CDN caches.

As illustrated, the peers 110A-D are each associated with a respective internet exchange 120A-B. In an embodiment, an internet exchange is an access point that Internet service providers (ISPs) and CDNs connect to for the purpose of exchanging traffic. Networks can connect and exchange traffic at an internet exchange using peering.

Further, the internet exchanges 120A-B are each connected to a localization network 140 using one or more routers 130A-B. In an embodiment, the routers 130A-B use BGP to direct traffic, and the localization network 140 is a communication network implemented on-premises, or otherwise local, to a content provider. Alternatively, the localization network 140 is a cloud computing network (e.g., a private cloud, public cloud, hybrid cloud, or any other suitable cloud network) or another suitable remote network. These are merely examples, and any number of peers, internet exchanges, and routers can be used. Further, this is an example communication network and any suitable components can be used.

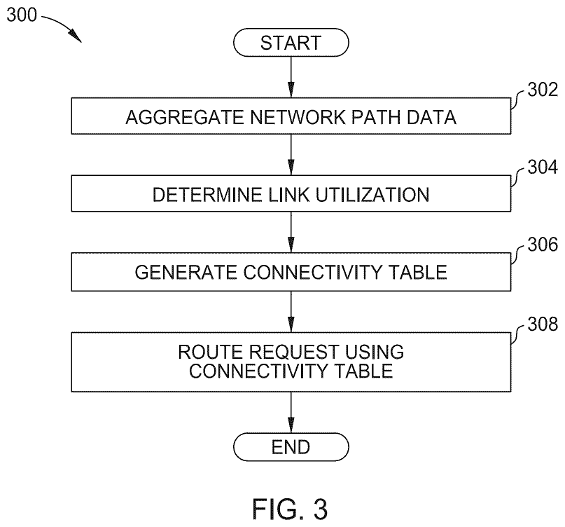

In an embodiment, the aggregation service 142 operates in the localization network 140, and gathers routing advertisements from the routers 130A-B. These routing advertisements describe both available paths for network traffic (e.g., to the peers 110A-D) and usage information for these paths. This is discussed further, below, with regard to FIGS. 3-5.

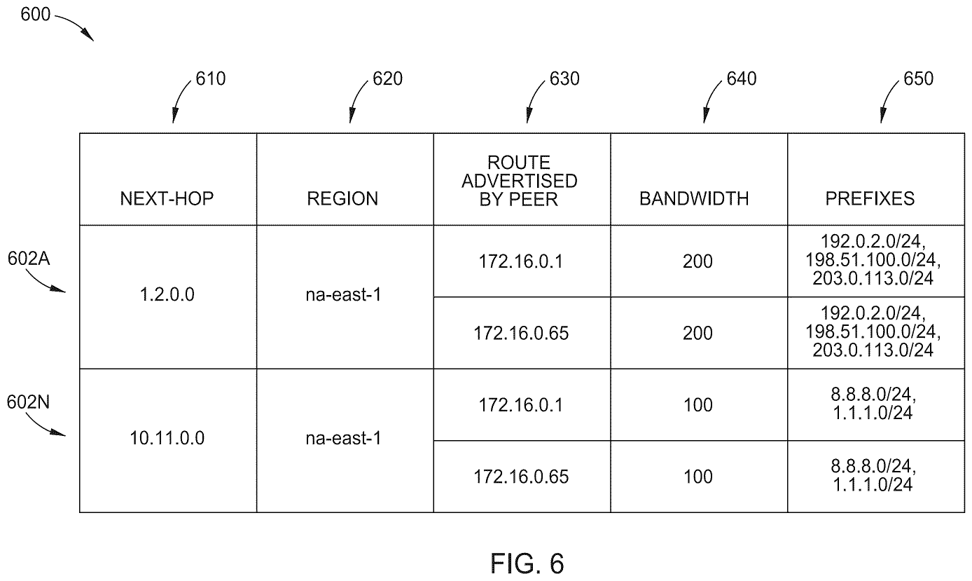

Further, in an embodiment, a localization service 144 populates a connectivity table 152 with the routing and usage information. This is discussed further, below, with regard to FIGS. 3 and 6. A routing service 150 can then use the information in the connectivity table 152 to route a client 160 to a preferred peer 110A-D (e.g., a suitable cache). This is discussed further, below, with regard to FIG. 3.

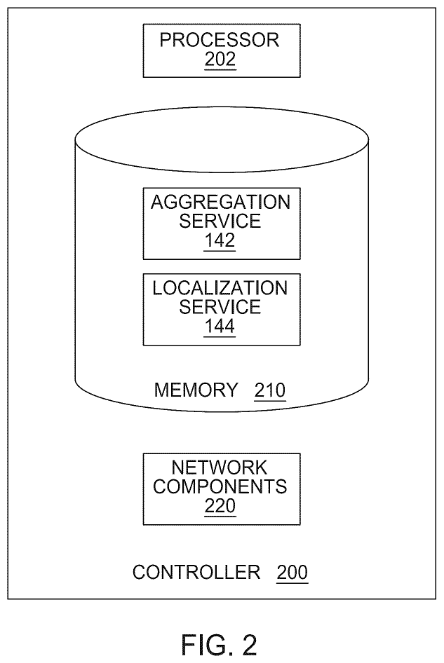

FIG. 2 is a block diagram illustrating a controller 200 for cache localization, according to one embodiment. In an embodiment, the controller 200 corresponds with one or more aspects of the computing environment 100 illustrated in FIG. 1. The controller 200 includes a processor 202, a memory 210, and network components 220. The processor 202 generally retrieves and executes programming instructions stored in the memory 210. The processor 202 is included to be representative of a single central processing unit (CPU), multiple CPUs, a single CPU having multiple processing cores, graphics processing units (GPUs) having multiple execution paths, and the like.

The network components 220 include the components necessary for the controller 200 to interface with components over a network (e.g., as illustrated in FIG. 1). For example, the controller 200 can be a part of the localization network 140 and the controller 200 can use the network components 220 to interface with remote storage and other compute nodes using the network components.

The controller 200 can interface with other elements in the system over a local area network (LAN), for example an enterprise network, a wide area network (WAN), the Internet, or any other suitable network. The network components 220 can include wired, WiFi or cellular network interface components and associated software to facilitate communication between the controller 200 and a communication network.

Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory. The memory 210 generally includes program code for performing various functions related to use of the controller 200. The program code is generally described as various functional “applications” or “services” within the memory 210, although alternate implementations may have different functions and/or combinations of functions.

Within the memory 210, an aggregation service 142 facilitates aggregation of routing and usage information for network paths. This is discussed further, below, with regard to FIGS. 3-5. A localization service 144 facilitates generating a connectivity table using aggregated routing and usage information for network paths. This is discussed further, below, with regard to FIGS. 3 and 6.

Although FIG. 2 depicts the aggregation service 142 and the localization service 144 as located in the memory 210, that representation is merely provided as an illustration for clarity. More generally, the controller 200 may include one or more computing platforms, such as computer servers for example, which may be co-located, or may form an interactively linked but distributed system, such as a cloud-based system (e.g., a public cloud, a private cloud, a hybrid cloud, or any other suitable cloud-based system). As a result, the processor 202 and memory 210 may correspond to distributed processor and memory resources within a computing environment.

FIG. 3 is a flowchart 300 illustrating cache localization, according to one embodiment. At block 302, an aggregation service (e.g., the aggregation service 142 illustrated in FIGS. 1-2) aggregates network path data. In an embodiment, network connectivity information for a given communication network (e.g., the communication network 102 illustrated in FIG. 1) is communicated within the network through a routing protocol.

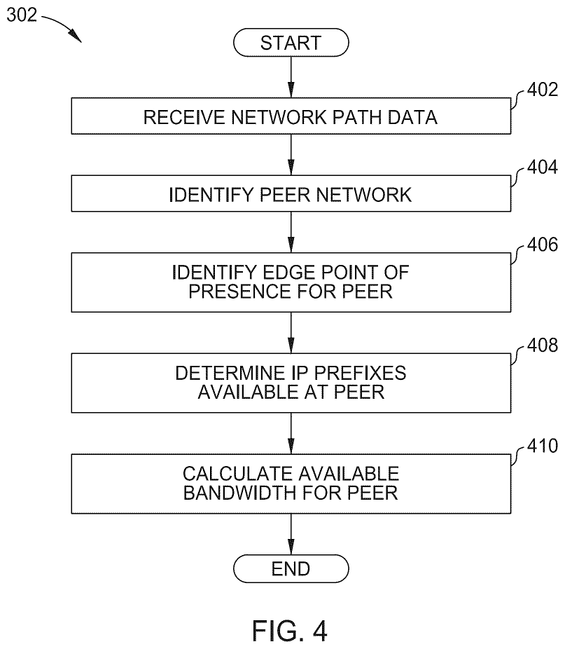

For example, Internet routers can use BGP to determine which next hop path or port a given packet should take to reach its destination. BGP advertisements can include network connectivity information, and can be forwarded to an aggregation point (e.g., the localization network 140 illustrated in FIG. 1). The aggregation service can receive the BGP advertisements and collect and aggregate the network path data. This is discussed further, below, with regard to FIG. 4.

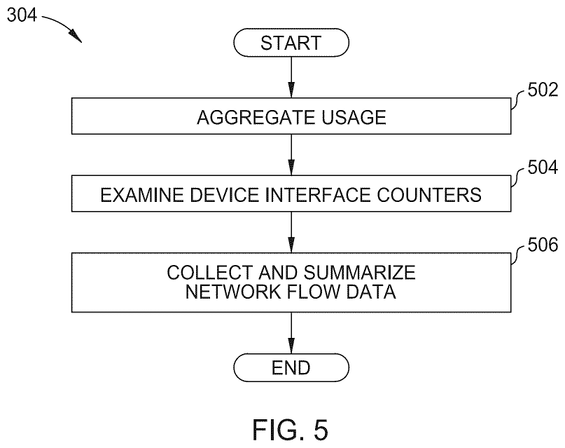

At block 304, the aggregation service determines link utilization. In an embodiment, at block 302 the aggregation service identifies the (total) bandwidth capacity for routing links. At block 304, the aggregation service determines how much of the capacity is used by existing sessions. For example, the aggregation service can determine real-time, or near real-time, utilization for links, including both links from a client device to a router and from a router to a peer. This is discussed further, below, with regard to FIG. 5.

At block 306, a localization service (e.g., the localization service 144 illustrated in FIGS. 1-2) generates a connectivity table reflecting one or more characteristics for routes. In an embodiment, the localization service uses the aggregated network path data generated at block 302, and the link utilization determined at block 304, to generate a connectivity table (e.g., the connectivity table 152 illustrated in FIG. 1) that can be used for routing traffic to the appropriate localized CDN cache. For example, the connectivity table can identify a next hop, a region, a router for an advertised route, bandwidth for the link, and associated IP prefixes. This is discussed further, below, with regard to FIG. 6.

At block 308, a routing service (e.g., the routing service 150 illustrated in FIGS. 1-2) routes a request using the connectivity table. In an embodiment, when the routing service receives a playback request (e.g., from the client 160 illustrated in FIG. 1), the routing service looks up the requesting client's IP address in the connectivity table (e.g., based on the corresponding prefix) and directs the request appropriately. As one example, the routing service can determine whether sufficient capacity exists on the link(s) identified using the connectivity table, and if so routes traffic along the identified link(s).

As another example, the routing service uses link capacity identified using the connectivity table as one factor, among many, in determining how to route the request. In an embodiment, in addition to determining whether sufficient capacity exists for one or more links identified using the connectivity table, the routing service determines whether a different constraint should take priority (e.g., a requirement to fulfil a minimum or maximum requirement for a given CDN). Further, the routing service can incorporate probability or chance. In this example, the routing service can use a randomization factor to identify whether to follow one or more links identified using the connectivity table. The routing service can use randomization to try to counteract potential inaccuracy or delay in the estimated capacity for the relevant links, and to avoid repeatedly sending traffic along a path that incorrectly appears to be preferred (e.g., based on the connectivity table data) but actually should not be preferred.

This is merely an example, and the routing service can use any suitable technique. For example, U.S. patent application Ser. No. 17/809,246, titled “Intelligent Content Delivery Network (CDN) Entity Routing,” (the “'246 Application”) describes certain techniques for selecting among CDNs using usage data. The '246 Application is herein incorporated by reference for its discussion of CDN routing.

In an embodiment, the routing service prefers the shortest path in terms of network distance. But this is merely an example. Alternatively, or in addition, the routing service can select a path based on additional factors. These can include cost (e.g., computational cost or monetary cost), contractual preferences or limitations, or any other suitable factors.

FIG. 4 is a flowchart illustrating aggregating network path data for cache localization, according to one embodiment. In an embodiment, FIG. 4 corresponds with block 302 illustrated in FIG. 3. At block 402, an aggregation service (e.g., the aggregation service 142 illustrated in FIGS. 1-2) receives network path data. For example, the aggregation service can receive forwarded BGP routing advertisements.

At block 404, the aggregation service identifies a peer network. In an embodiment, the aggregation service can aggregate the BGP routing data received from the BGP advertisements by indexing the routing data on one or more of a variety of properties. As one example, the aggregation service can identify the peer network to which a given hop is connected. The aggregation service can identify the peer network based on identifying the Internet exchange point (IXP) connected to, the private network interconnect (PNI) connected to, or using any other suitable technique.

The peer network is merely one example property suitable for use in aggregation. At block 406, the aggregation service identifies the edge point of presence (PoP), along with the router and interface in some embodiments, to which the peer is connected. At block 408 the aggregation service indexes the routing data based on the set of IP prefixes (e.g., IPv4 prefixes, IPv6 prefixes, or both). Either, or both, of these can also be used for aggregation (e.g., instead of, or in addition to, the peer network).

At block 410, the aggregation service indexes the routing data based on the amount of bandwidth available to the peer. In an embodiment, bandwidth is shared amongst many prefixes. These are merely examples, and the aggregation service can index the routing data based on any combination of one or more of these properties, or on any other suitable properties.

FIG. 5 is a flowchart illustrating determining link utilization for cache localization, according to one embodiment. In an embodiment, FIG. 5 corresponds with block 304 illustrates in FIG. 3. At block 502, an aggregation service (e.g., the aggregation service 142 illustrated in FIGS. 1-2) aggregates usage.

As discussed above in relation to block 304, after the aggregation service determines the capacity of links, it then determines how much of the capacity is used by existing sessions. This can be done through any combination of several techniques. In an embodiment, the aggregation service aggregates usage. The aggregation service can identify information from one or more clients (e.g., suitable client reports or usage data), and can use that information to aggregate client usage. For example, the aggregation service can identify client quality of experience (QoE) telemetry (e.g., peak and average bitrate), and can summarize that QoE telemetry for a grouping (e.g., based on PoP, prefix, or any other suitable grouping).

At block 504, the aggregation service examines device interface counters. In an embodiment, routers include counters identifying a number of devices associated with the router. The aggregation service can use simple network management protocol (SNMP), or any other suitable technique, to examine these device interface counters. As another example, the aggregation service can query a time series database (e.g., InfluxDB). For example, statistics reflecting usage for routers or other devices can be maintained in a time series database. The aggregation service can retrieve this information.

At block 506, the aggregation service collects and summarizes network flow data (e.g., sampled flow (sFLOW) data). In an embodiment, sFLOW data, device counters, or other suitable data may be collected and used for other purposes or by one or more third party services. In one example, the aggregation service uses sFLOW data, device counters, or both, collected by a third party service. Alternatively, or in addition, the aggregation service collects sFLOW data, device counters, or any other suitable data. These are merely examples, and the aggregation service can use any suitable combination of one or more of these techniques, along with any other suitable techniques, to determine link usage.

FIG. 6 illustrates a connectivity table 600 for cache localization, according to one embodiment. Although the illustrated table 600 includes certain information (e.g., five specific columns each containing corresponding information), in other embodiments, the table may include more columns (e.g., more information not given in the illustrated table 600) or fewer columns (e.g., a subset of the information given in the illustrated table 600). In an embodiment, the connectivity table 600 illustrates one example connectivity table generated at block 306 illustrated in FIG. 3. For example, each row 602A-N can relate to a given Next-hop routing interface (e.g., a layer 3 (L3) interface). In an embodiment, a prefixes column 650 includes IP prefixes for client IP addresses. Further, in an embodiment, the prefixes 650 can include IPv4 IP addresses, IPv6 IP address, or any other suitable addresses. For example, a localization service (e.g., the localization service 144 illustrated in FIGS. 1-2) can correlate between IPv4 and IPv6 addresses, and can store either, or both.

As another example, a bandwidth column 640 can identify the available bandwidth for a given link (e.g., in Gbps, or any other suitable measurement). The route advertised by peer column 630 can identify the router to use for the associated link (e.g., by IP address). The region column 620 can identify the region to use (e.g., to include in a uniform resource locator (URL) designating the destination). The Next-hop column 610 can identify the next L3 interface for routing. In an embodiment, the Next-hop is a next step in the routing (e.g., a next L3 interface) and not necessarily a final destination.

In an embodiment, a per-link usage (e.g., determined at block 304 illustrated in FIG. 3) that can be matched with the route advertised by peer column 630 to identify the usage on every peering link. A routing service (e.g., the routing service 150 illustrated in FIG. 1) can avoid using full, or nearly full, links to service future requests. In an embodiment, the routing service can identify full links based on a threshold percentage (e.g., 80%) of full capacity. This threshold can be pre-determined (e.g., by an administrator or a suitable machine learning (ML) model), identified on the fly, or identified using any other suitable technique.

Reviewing the illustrated examples in FIG. 6, moving from right to left, as part of a row 602A the prefixes 192.0.2.0/24, 198.51.100.0/24, and 203.0.113.0/24 are associated with a link that has a total bandwidth capacity of 200 Gbps through a router at the IP address 172.160.0.1 to the region na-east-1 for a Next-hop interface at an IP address 1.2.0.0. Note that although the bandwidth capacity of the link maybe one value (e.g., 200 Gbps), in some aspects, the actual available capacity remaining may be smaller (e.g., due to the current utilization of the link). Similarly, within the row 602A, the prefixes 192.0.2.0/24, 198.51.100.0/24, and 203.0.113.0/24 are also associated with another link that has a bandwidth capacity of 200Gbps through a router at the IP address 172.160.0.65 to the region na-east-1 for a Next-hop interface at an IP address 1.2.0.0.

The row 602N includes the prefixes 8.8.8.0/24 and 1.1.1.0/24, which are associated with a link that has a bandwidth capacity of 100 Gbps through a router at the IP address 172.160.0.1 to the region na-east-1 for a Next-hop interface at an IP address 10.11.0.0. Similarly, within the row 602N, the prefixes 8.8.8.0/24 and 1.1.1.0/24 are associated with another link that has a bandwidth capacity of 100 Gbps through a router at the IP address 172.160.0.65 to the region na-east-1 for a Next-hop interface at an IP address 10.11.0.0.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
aggregating network path data received from a plurality of routing advertisements for a communication network, the communication network comprising a plurality of content delivery network (CDN) caches;
determining link utilization for a plurality of links in the communication network relating to the plurality of CDN caches;
generating a connectivity table reflecting, for each of a plurality of routes in the communication network, one or more characteristics of the routes; and
routing communication between a requesting client and a first CDN cache, of the plurality of CDN caches, based on the connectivity table and the determined link utilization.

2. The method of claim 1, wherein the connectivity table comprises, for each of the plurality of routes, at least one of: (i)one or more client internet protocol (IP) address prefixes, (ii) a bandwidth capacity, or (iii) a destination address.

3. The method of claim 2, wherein the one or more client IP address prefixes comprise at least one of: (i) IPv4 IP addresses, (ii) IPv6 IP addresses, or (iii) both IPv4 and IPv6 IP addresses.

4. The method of claim 2, wherein the destination address comprises at least one of a router address, a region, or a next-hop.

5. The method of claim 4, wherein the destination address comprises all of the router address, the region, and the next-hop.

6. The method of claim 1, wherein the routing advertisements comprise border gateway protocol (BGP) advertisements.

7. The method of claim 6, wherein aggregating the network path data comprises indexing the BGP routing advertisements using at least one of: (i) an identified peer network, (ii) an identified point of presence (PoP) for a peer, (iii) one or more IP prefixes available at a peer, or (iv) an amount of bandwidth available for a peer.

8. The method of claim 7, wherein aggregating the network path data comprises indexing the BGP routing advertisements using the identified peer network, and wherein the identified peer network relates to at least one of: (i) an Internet exchange point (IXP) (ii) a private network interconnect (PNI).

9. The method of claim 7, wherein aggregating the network path data comprises indexing the BGP routing advertisements using all of: (i) the identified peer network, (ii) the identified point of presence (PoP) for a peer, (iii) the or more IP prefixes available at a peer, and (iv) the amount of bandwidth available for a peer.

10. The method of claim 1, wherein determining link utilization for the plurality of links relating to the plurality of CDN caches comprises at least one of: (i) aggregating client usage data or (ii) examining device interface counters.

11. A non-transitory computer program product comprising:
one or more non-transitory computer readable media containing, in any combination, computer program code that, when executed by operation of any combination of one or more processors, performs operations comprising:
aggregating network path data received from a plurality of routing advertisements for a communication network, the communication network comprising a plurality of content delivery network (CDN) caches;
determining link utilization for a plurality of links in the communication network relating to the plurality of CDN caches;
generating a connectivity table reflecting, for each of a plurality of routes in the communication network, one or more characteristics of the routes; and
routing communication between a requesting client and a first CDN cache, of the plurality of CDN caches, based on the connectivity table and the determined link utilization.

12. The non-transitory computer program product of claim 11, wherein the connectivity table comprises, for each of the plurality of routes, one or more client internet protocol (IP) address prefixes, a bandwidth capacity, and a destination address.

13. The non-transitory computer program product of claim 12, wherein the destination address comprises at least one of a router address, a region, or a next-hop.

14. The non-transitory computer program product of claim 11,
wherein the routing advertisements comprise border gateway protocol (BGP) advertisements, and
wherein aggregating the network path data comprises indexing the BGP routing advertisements using at least one of: (i) an identified peer network, (ii) an identified point of presence (PoP) for a peer, (iii) one or more IP prefixes available at a peer, or (iv) an amount of bandwidth available for a peer.

15. The non-transitory computer program product of claim 11, wherein determining link utilization for the plurality of links relating to the plurality of CDN caches comprises at least one of: (i) aggregating client usage data or (ii) examining device interface counters.

16. A system, comprising:
one or more processors; and
one or more memories storing a program, which, when executed on any combination of the one or more processors, performs operations, the operations comprising:
aggregating network path data received from a plurality of routing advertisements for a communication network, the communication network comprising a plurality of content delivery network (CDN) caches;
determining link utilization for a plurality of links in the communication network relating to the plurality of CDN caches;
generating a connectivity table reflecting, for each of a plurality of routes in the communication network, one or more characteristics of the routes; and
routing communication between a requesting client and a first CDN cache, of the plurality of CDN caches, based on the connectivity table and the determined link utilization.

17. The system of claim 16, wherein the connectivity table comprises, for each of the plurality of routes, one or more client internet protocol (IP) address prefixes, a bandwidth capacity, and a destination address.

18. The system of claim 17, wherein the destination address comprises at least one of a router address, a region, or a next-hop.

19. The system of claim 16,
wherein the routing advertisements comprise border gateway protocol (BGP) advertisements, and
wherein aggregating the network path data comprises indexing the BGP routing advertisements using at least one of: (i) an identified peer network, (ii) an identified point of presence (PoP) for a peer, (iii) one or more IP prefixes available at a peer, or (iv) an amount of bandwidth available for a peer.

20. The system of claim 16, wherein determining link utilization for the plurality of links relating to the plurality of CDN caches comprises at least one of: (i) aggregating client usage data or (ii) examining device interface counters.
